(19) United States
(12) Patent Application Publication
(10) Pub. No.: US 2020/0313496 A1
(43) Pub. Date: Oct. 1, 2020

(54) VOLTAGE REGULATOR ASSEMBLY WITH A BRUSH HOLDER FOR A ROTARY ELECTRICAL MACHINE

(71) Applicant: Valeo Equipements Electriques Moteur, Creteil (FR)

(72) Inventors: Nathalie Canitrot, Creteil (FR); Christophe Dugue, Creteil (FR); Henri-Charles Smaeghe, Creteil (FR); Julien Battut, Creteil (FR); Laurent Ledoux, Creteil (FR); Hugues Tempez, Creteil (FR); Benjamin Loret, Creteil (FR); Axel Dos-Santos, Creteil (FR)

(73) Assignee: Valeo Equipements Electriques Moteur, Creteil (FR)

(21) Appl. No.: 16/061,761

(22) PCT Filed: Dec. 13, 2016
(86) PCT No.: PCT/FR2016/053346

§ 371 Date: Jun. 13, 2018

(30) Foreign Application Priority Data
Dec. 14, 2015 (FR) 1562277

(51) Int. Cl. H02K 5/14; H02K 1/24; H02K 9/06; H02K 9/28; H02K 19/36

(52) U.S. Cl. CPC H02K 5/141; H02K 1/243; H02K 19/365; H02K 9/28; H02K 9/06

(57) ABSTRACT

A voltage regulator with brush holder assembly (100) for a rotary electric machine intended for an automotive vehicle, which assembly comprises: —a brush holder comprising brushes that are capable of coming into electrical contact with a rotor of the rotary electric machine in order to apply an excitation signal thereto; —a microcontroller for regulating said excitation signal; —a body made of electrically insulating material, said body taking the overall shape of a T and in which said brush holder and said microcontroller are housed, characterized in that the voltage regulator with brush holder assembly (100) comprises two parts: —a first part (200) forming a central portion of the T-shaped body and extending along a first axis (z1-z2), said first part (200) comprising a housing (201) for accommodating the brush holder and a second part (300) forming a lateral portion of the T-shaped body and extending along a second axis (y1-y2) perpendicular to said first axis (z1-z2), said integrated circuit being housed in said second part (300).

### TECHNICAL FIELD

The present invention relates to a voltage regulator with a brush holder for a rotary electrical machine, in particular an alternator or an alternator-starter of a motor vehicle, and a rotary electrical machine comprising an assembly of this type.

### TECHNOLOGICAL BACKGROUND OF THE INVENTION

In the prior art, many rotary electrical machines are equipped with a current rectification device and a voltage regulator assembly with a brush-holder. For example, FIG. 1 shows a machine of this type in the form of a compact polyphase alternator, in particular for a motor vehicle. This alternator, which in this case has internal ventilation, transforms mechanical energy into electrical energy. This machine substantially comprises a housing 1, and inside the latter, a rotor 2 which is integral in rotation with a shaft 3 and a polyphase stator 4, which surrounds the rotor with the presence of a slight air gap, and comprises a body in the form of a set of metal plates provided with notches, in this case of the half-closed type, equipped with notch insulation for fitting of the coil of the phases of the stator, each comprising a winding forming a chignon 5 on both sides of the body of the stator. The windings of the coil are obtained for example from a continuous wire covered with enamel, or from conductive elements in the form of a bar covered with enamel, such as pins which are connected to one another for example by welding. These windings are for example three-phase windings connected in the form of a star or a triangle, the outputs 33 of which are connected to inputs 15 belonging to a current rectification device 25 comprising current rectification elements 93, 94 such as diodes or transistors of the MOSFET type belonging to at least one rectifier bridge.

The number of phases depends on the applications, and can be more than three, as described for example in document WO 03/009452, one or two rectifier bridges being able to be provided. The rotor in FIG. 1 is a rotor with claws 2. It comprises two magnet wheels 7, 8, which are axially juxtaposed and have an annular form, each having a transverse flange provided on its outer periphery with teeth 9 with a trapezoidal form facing axially towards the flange of the other magnet wheel, with the tooth of one magnet wheel penetrating into the space which exists between two adjacent teeth 9 of the other magnet wheel. The number of teeth 9 depends on the applications, and in particular on the number of phases of the stator. According to one embodiment, eight teeth are provided per magnet wheel. As a variant, each magnet wheel comprises six or seven teeth. In this case, the shaft 3 is rendered integral with the magnet wheels 7, 8 by force fitting of the hardest shaft 3 into the bores in the wheels 7, 8, with the shaft 3 having knurled portions for this purpose.

A cylindrical core, which in this case is in two parts, is interposed axially between the flanges of the wheels 7, 8. This core supports an excitation coil 101 on its outer periphery.

The shaft 3 of the rotor 2 supports on its front end a drive unit, such as pulley 112 belonging to a movement transmission device with at least one belt between the alternator and the thermal engine of the motor vehicle, and, on its rear end 13, with a reduced diameter, it supports collector rings which are connected by wired connections at the ends of the excitation coil of the rotor. The wired connections and the collector rings in this case belong to an added-on collector of the type described in document FR 2 710 197. Brushes (with no reference) belong to a brush-holder, and are arranged such as to rub on the collector rings. The brush-holder is connected to a voltage regulator, in order to form with the latter a voltage regulator with a brush-holder 14. The voltage regulator regulates the voltage of the alternator, in order to protect the consumers, and to recharge the battery to the correct voltage.

In all cases, when the excitation coil 101 is supplied electrically via the brushes or without them, the rotor 2, which is made of ferromagnetic material, is magnetised, and becomes an inductor rotor with formation of magnetic poles at the teeth of the magnet wheels.

This inductor rotor creates an alternating induced current in the induced stator when the shaft 3 rotates, with the rectifier bridge(s) of the current rectification device 25 making it possible to transform the induced alternating current into a direct current, in particular in order to supply the charges and consumers of the on-board network of the motor vehicle, as well as to recharge the battery of the said vehicle. In FIG. 1, the housing 1 supports in the interior of its outer periphery the body of the stator 4, and supports centrally with rotation the shaft 3. This housing is in this case in two parts, i.e. a front flange 116 adjacent to the pulley 112, and a rear flange 50 provided with a base 56 supporting the assembly 14 in a single piece which forms a voltage regulator with a brush-holder, and at least one rectifier bridge of the current rectification device 25. As a variant, it is the front flange which supports the assembly in a single piece consisting of the voltage regulator—brush-holder, and at least one rectifier bridge of the current rectification device 25.

In these two embodiments, a perforated protective cover is provided surrounding the voltage regulator and the current rectification device 25. This cover has the reference 31 in FIG. 1, and comprises a base provided with openings, as can be seen better in FIGS. 6 and 8 of document WO 03/009452.

The flanges 116 and 50 are known in a conventional manner respectively as the front bearing 116 and the rear bearing 50. They form a housing. These bearings 116, 50 in this case have a hollow metal form, and are for example based on aluminium, which makes it possible to obtain the required form by moulding. These bearings are connected electrically to the earth of the vehicle via lugs with no reference which they comprise for securing of the alternator on a fixed part of the vehicle.

They each support centrally a ball bearing, respectively 19 and 20, for fitting with rotation of the shaft 3 of the rotor 2. A brace 159 is in this case interposed between the rotor 2 and the bearing 19, which has a diameter larger than that of the bearing 20.

In FIG. 1, on the outer periphery of the body of the stator 4, a resilient system is provided in order to filter the vibrations, with a flat seal 140 at the front and buffers 141 at the rear, with flexible heat-conductive resin being interposed between the front bearing and the body of the stator in order to discharge the heat. As a variant, the bearings 116, 50 support the body of the stator 4 rigidly. It will be noted that the axial axis of symmetry X-X of the shaft 3 also constitutes the axial axis of symmetry 5 of the rotor 2 and the axis of rotation of the alternator. The bearings 116 and 50, which globally have an annular form, comprise a base 56, with an orientation which is globally axial relative to the axis X-X. This base 56 is extended on its outer periphery 10 by an annular skirt 55 with an orientation which is globally axial relative to the axis X-X. The bases and the skirts of the bearings are provided in FIG. 1 with openings 51, 53, respectively for input and output, in order to permit the cooling 15 of the alternator by circulation of air. For this purpose, the rotor 2 supports at one of its axial ends at least a fan which is designed to ensure this circulation of the air. In the example represented, a front fan 123 is provided on the front frontal face 20 of the rotor, and a rear fan 124, which is more powerful, is provided on the rear dorsal face of the rotor. Each fan is provided with a plurality of blades 126. The base 56 of the bearing 50 also has openings 34 for the passage of the outputs 33 of the phases. This base 56 is also tapped locally for screwing of bolts 32 for securing of the cover, passing through the device 25. More specifically, the cover 31 surrounds the device 25 and the voltage regulator assembly with a brush-holder 14. It is fitted by being snapped onto the threaded end of the bolts 32. For this purpose, in a known manner, the cover 31 made of plastic material comprises a duct (with no reference in FIG. 1) associated with each bolt 32. In its interior, each duct has resiliently deformable lugs, which are designed to be engaged by snapping together with the threaded end of the bolt 32. In the aforementioned documents WO 03/009452 and FR 2 744 575, the current rectification device comprises diodes which are provided with a base, known as a cap, comprising a solid main part extended axially by a pedestal which has on its free end a securing face for a semiconductor element interposed between the pedestal and the head of a connection element in the form of a rigid wire, known as the diode tail or diode shaft. Resin coats the head of the diode tail and the semiconductor element. This resin is integral with the cap of the diode.

The current rectification device, which is supported by the rear bearing, or as a variant by the front bearing, comprises a plurality of positive diodes 20 supported by a positive support, a plurality of negative diodes supported by the base of the bearing, and a connector in order to connect the diode tails to the outputs of the phases of the stator. The diodes constitute current rectification elements. According to another embodiment these are replaced by transistors of the MOSFET type.

The positive support and the bearing are made of metal, whereas the connector comprises a body made of plastic material in which there are embedded electrically conductive tracks which are stripped in some locations in order in particular to form the electrical connections with the tails of the positive and negative diodes.

As can be seen in particular in FIG. 5 of this document WO 03/009452, the diodes extend parallel to the axis of the alternator, and the connector is implanted radially above the positive support which is electrically insulated by the rear bearing.

This arrangement is not entirely satisfactory. In particular, the fitting of the components in the voltage regulator with a brush-holder is complex and costly.

### SUBJECT OF THE INVENTION

The objective of the present invention is thus to eliminate this disadvantage by means of an improved voltage regulator assembly with a brush-holder.

The subject of the invention is a voltage regulator assembly with a brush-holder for a rotary electrical machine designed for a motor vehicle, which assembly comprises:
a brush-holder provided with brushes which can come into electrical contact with a rotor of the rotary electrical machine, in order to provide it with an excitation signal;
a microcontroller for regulation of the said excitation signal;
a body made of electrically insulating material, the said body being globally in the form of a “T”, and in which the said brush-holder and the said microcontroller are accommodated.

According to a general characteristic, the voltage regulator assembly with a brush-holder comprises two parts:
a first part forming a central part of the body in the form of a “T”, and extending according to a first axis (z1-z2), the said first part comprising a receptacle forming a brush-holder; and
a second part forming a lateral part of the body in the form of a “T”, and extending according to a second axis (y1-y2) which is perpendicular to the said first axis (z1-z2), the said second part comprising a receptacle forming a case for the regulation microcontroller.

Assembling these first and second parts provides an assembly which includes the brush-holder and the microcontroller.

According to one embodiment, the said assembly comprises at least one slide so that the first part which forms a central part slides relative to the second part according to the said first axis.

By means of this slide connection, the first part and the second part are easily assembled, after having added the brushes and the microcontroller respectively.

According to one embodiment, the slide connection comprises at least one rail for guiding the second part and studs of the first part, each of the said studs cooperating with a guide rail.

According to one embodiment, the first part comprises closure walls, each of the closure walls being supported on a guide rail of the second part in a direction transverse to the said guide rail, in order to stop it up.

This prevents water from being able to infiltrate via the guide rail after fitting of the first part on the second part.

According to one embodiment, the receptacle for receipt of the brush-holder comprises at least two ridges, and the second part comprises semi-cylindrical guides, with the said two ridges cooperating with the two semi-cylindrical guides in order to permit guiding of the first part relative to the second.

This therefore permits the fitting of the first part on the second part.

According to one embodiment, the second part comprises a receipt receptacle in which the first part is fitted in order to form the said body.

In cooperation with the receptacle designed for the brush-holder 201, the fitting of the first part within the receipt receptacle permits a significant improvement in the sealing of the brushes.

According to one embodiment, the receipt receptacle comprises two ends which extend projecting in the direction of the first part, and the said two ends cooperate with two projections of the first part, such that the first part can be inserted between the said two ends.

This permits the fitting and removal of the first part relative to the second part. This provides firstly durable securing, and secondly, in the case of a replacement, only the one of the two parts which is defective needs to be replaced.

According to one embodiment, the first part comprises two faces perpendicular to the said second axis (y1-y2) and two first walls which extend projecting according to the said first axis in the direction of the second part from the said two faces, the said receipt receptacle comprises two second walls which delimit it, the said two second walls extending according to the said first axis in the direction of the first part, and each of the first walls co-operates with one of the said second walls.

This improves further the sealing within the receipt receptacle.

According to one embodiment, each of the first walls has an axial length which is sufficient to cover one of the said second walls at least partly.

According to one embodiment, at least one of the two faces has an additional thickness.

The retention of water in this area is limited. In fact, the water stored could eventually infiltrate towards the receipt receptacle.

According to one embodiment, the additional thickness comprises a damming part in the form of an “L” covering the first wall, the said damming part being formed by a first longitudinal part extending according to the said first axis (z1-z2) and a second part extending according to the said second axis (y1-y2) in the direction of the second wall with which the said first wall co-operates.

The retention of the water in this area is limited more efficiently by forming a dam which prevents the water from infiltrating.

According to one embodiment, the second part comprises a separation wall which extends according to the second axis (y1-y2), with the said separation wall separating the receipt receptacle into two receipt sub-receptacles with an equivalent volume.

This therefore prevents short-circuiting between the two brushes, with one sub-receptacle being dedicated to each brush.

According to one embodiment, the second part is superimposed by a seal extending according to the said second axis, with one of the ends of the seal being supported on one of the second walls.

The sealing is improved for the components which are accommodated within the second part, in particular the microcontroller and the smoothing capacitors.

According to one embodiment, the first part comprises a first excitation terminal comprising a stud which extends according to the first axis (z1-z2), and the second part supports on one of the two ends a second excitation terminal, the said second terminal being provided with a guide groove for cooperation with the said stud, in order to facilitate the relative positioning of the first terminal in relation to the second terminal.

According to one embodiment, the said assembly comprises a heat dissipation plate, wherein the second part comprises an inner face facing towards the first part and an outer face facing towards the other side, with the said outer face extending on a plane perpendicular to the first axis (z1-z2), and wherein the outer face is formed at least partly by the said dissipation plate.

The dissipation plate thus forms a substantial surface area of the outer face, which improves the cooling of the components of the second part, in particular the microcontroller and the smoothing capacitors.

According to one embodiment, the microcontroller is accommodated in the second part, such that it comes into thermal contact, for example in accordance with its largest surface area, with the heat dissipation plate.

For example, the voltage regulator assembly with a brush-holder comprises a smoothing capacity of the battery terminal to which the electrical machine is connected, and the capacitor extends according to the first axis (z1-z2) in order to reduce the size of the voltage regulator assembly with a brush-holder according to the second axis (y1-y2).

The invention also relates to a rotary electrical machine comprising a housing provided with cooling windows, with a rotor which is accommodated in the said housing being able to rotate around an axis of rotation (X-X) and to blow air discharged by the said cooling windows, the said rotor being provided with collector rings in order to receive an excitation current.

According to a general characteristic, the machine comprises a voltage regulator assembly with a brush-holder as previously described, the brushes of the said assembly being in electrical contact with the said collector rings.

According to one embodiment, the voltage regulator assembly with a brush-holder is fitted on the housing accommodated within a protective cover fitted on the housing, and the machine comprises a closure ring arranged between the housing and the protective cover, in order to prevent the input of the air discharged by the cooling windows.

According to one embodiment, the protective cover is provided with an opening for the intake of cooling air, with the said opening being delimited by two vertical walls of the protective cover, such that the cooling air is guided towards a face of the voltage regulator assembly with a brush-holder, which face faces towards the exterior of the machine and extends on the plane perpendicular to the said first axis (z1-z2).

For example, the cooling air is thus guided towards the dissipation plate, in order for it to be cooled by convection.

### BRIEF DESCRIPTION OF THE FIGURES

The invention will be better understood by reading the following description and examining the figures which accompany it. These figures are provided purely by way of illustration, and in no way limit the invention.

FIG. 1, already described, is a view in axial cross-section of a rotary electrical machine according to the prior art.

FIG. 2 is a view in perspective of the voltage regulator assembly with a brush-holder according to the invention.

FIG. 3 is a view in perspective of the first part of the voltage regulator assembly with a brush-holder according to the invention.

FIG. 4 is a view in perspective of the second part of the voltage regulator assembly with a brush-holder according to the invention.

FIGS. 5 and 6 are views in cross-section of the voltage regulator assembly with a brush-holder according to the invention.

FIG. 7 is a view in perspective of the voltage regulator assembly with a brush-holder according to the invention.

FIG. 8 is a view in cross-section of an electrical machine provided with the voltage regulator assembly with a brush-holder.

FIG. 9 is a view from above of an electrical machine provided with the voltage regulator assembly with a brush-holder.

### DESCRIPTION OF EMBODIMENTS OF THE INVENTION

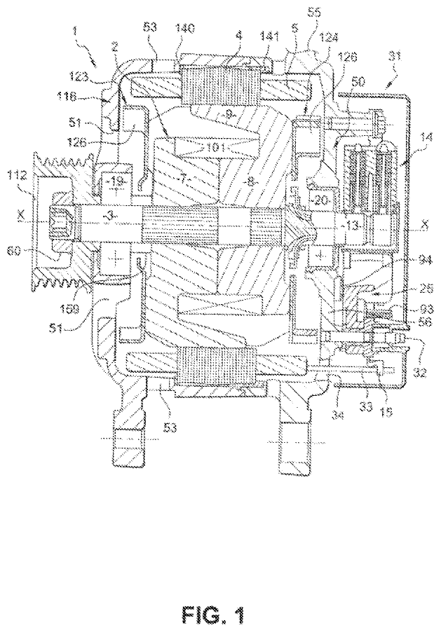

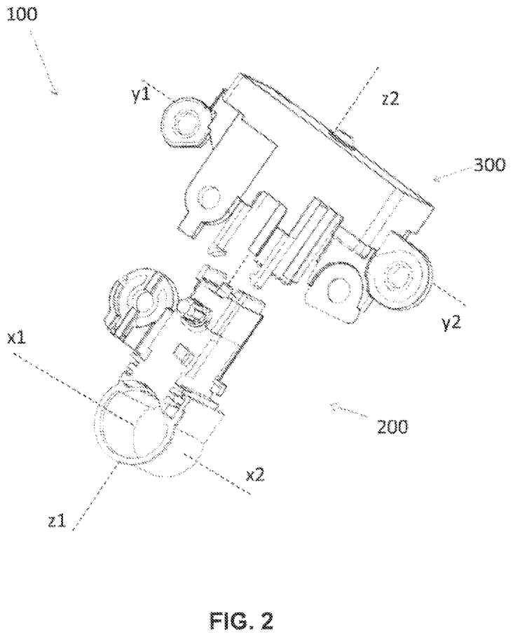

FIG. 2 illustrates a voltage regulator assembly with a brush-holder 100 which can replace a voltage regulator assembly with a brush-holder 14 in a rotary electrical machine such as the one shown in FIG. 1.

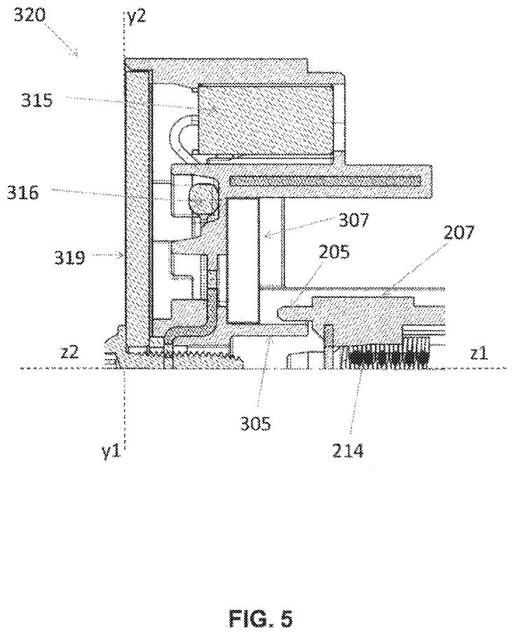

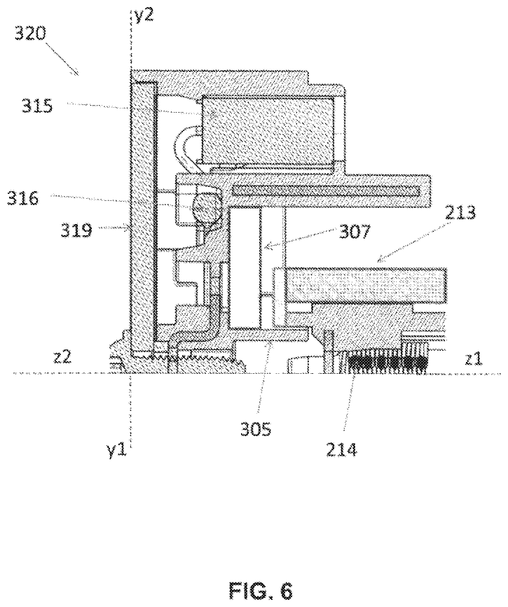

For this purpose, the voltage regulator assembly with a brush-holder comprises in particular (not shown in FIG. 2):
a brush-holder 214 shown in FIGS. 5 and 6. The brush-holder 214 comprises brushes 215 which can come into electrical contact with the rotor 2 shown in FIG. 1 of the rotary electrical machine, in order to provide it with an excitation signal;
a microcontroller 312 for regulation of the excitation signal, shown in FIG. 7.

The voltage regulator assembly with a brush-holder 100 also comprises a body made of electrically insulating material which is globally in the form of a “T” and comprises two parts:
a first part 200 forming a central part of the body in the form of a “T” and extending according to a first axis (z1-z2), the said first part 200 comprising a receptacle 201 in order to receive the brush-holder 214; and
a second part 300 forming a lateral part of the body in the form of a “T” and extending according to a second axis (y1-y2) perpendicular to the said first axis (z1-z2), the said microcontroller 312 being accommodated in the said second part 300.

The part 200 comprises a third axis x1-x2 which coincides with the axis X-X in FIG. 1, when the assembly 100 is installed in the aforementioned electrical machine 1.

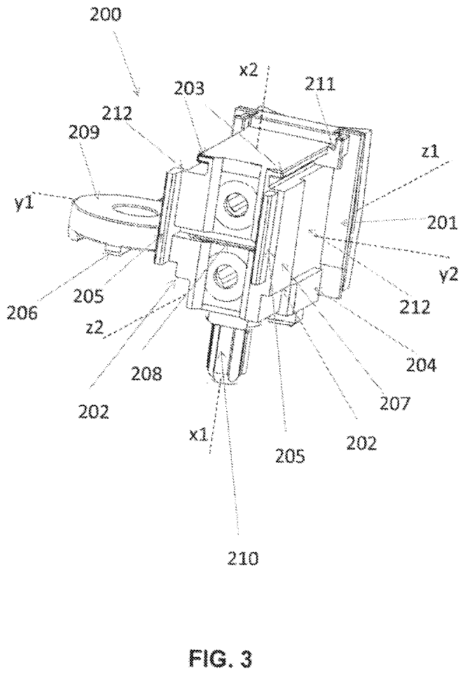

FIG. 3 illustrates in greater detail the first part 200. It can have globally the form of a rectangular parallelepiped provided with two protuberances. The rectangular parallelepiped has six faces. Each of the six faces is perpendicular to an axis taken from amongst the first, second and third aforementioned axes.

For example, the first part comprises two faces 212 perpendicular to the second axis (y1-y2) and the first protuberance is a first excitation terminal 209 attached to the face 212 situated on the y1 side. According to one embodiment, the first part also comprises two faces perpendicular to the third axis (x1-x2) and the second protuberance is a locating pin 210 which is attached to the face perpendicular to the third axis on the x1 side.

The two faces 212 and the two faces perpendicular to the third axis (x1-x2) can form a receptacle 201 in order to receive the brushes.

For example, at least one of the two faces 212 has an additional thickness 207 at its junction with one of the first walls 205. According to this example, the additional thickness 207 can comprise a damming part 213 in the form of an “L” which covers the first wall 205. The part 213 is formed for example by a first longitudinal part which extends according to the said first axis (z1-z2) and a second part which extends according to the said second axis (y1-y2) in the direction of a wall of the second part 300.

The first part 200 also comprises two projections 204, each being situated on a face 212. In addition, the first part 200 can comprise two first walls 205 which extend projecting according to the first axis (z1-z2) in the direction of the second part 300, starting from the said two faces 212. According to one embodiment, the first excitation terminal 209 comprises a stud 206 which extends according to the first axis (z1-z2). The first part 200 can also comprises closure walls 211. The first part 200 can additionally comprise at least one stud 203. For example, the first part comprises two studs, each being situated on a face 212. According to this example, the studs extend according to the first axis (z1-z2). The receptacle 201 can comprise two ridges 202. Finally, the face which is perpendicular to the first axis (z1-z2) and is situated on the second part side can be provided with a groove 208 according to the second axis (y1-y2), with the groove separating the said face into two.

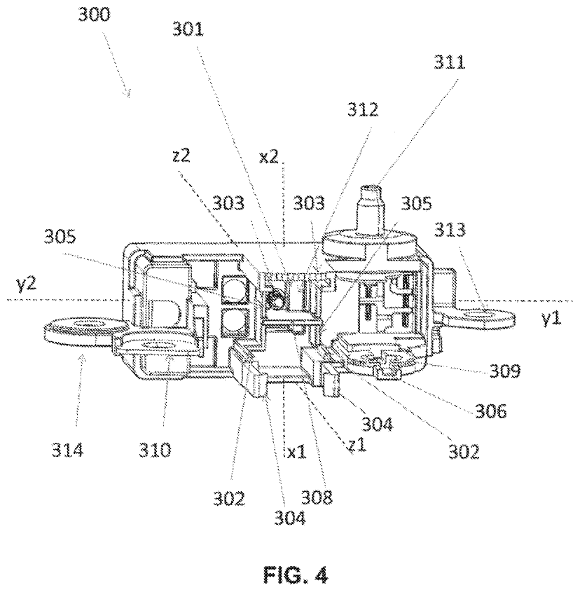

The projections 204, the first walls 205, the stud 206 of the excitation terminal 209, the closure walls 211, the stud 203, the two ridges 202 and the groove 208 are configured to cooperate with the second part 300, as described hereinafter with reference to FIG. 4.

FIG. 4 illustrates in greater detail the second part 300. It can have globally the form of a rectangular parallelepiped provided with two protuberances. The rectangular parallelepiped has six faces. Each of the six faces is perpendicular to an axis from amongst the aforementioned first, second, and third axes.

The second part extends mainly in a direction of the second axis (y1-y2). In other words, the longest length of the rectangular parallelepiped of which it has the form is that according to the axis (y1-y2). For example, the aforementioned first protuberance which extends from a face perpendicular to the second axis (y1-y2) is a terminal 314 for connection to the potential B+ of a battery of the motor vehicle. It is situated on the y2 side.

For example, the aforementioned second protuberance which extends from a face perpendicular to the second axis (y1-y2) is a phase terminal 313 which is connected to one of the phases of the coil of the stator. According to this example, it can be situated on the y1 side. The phase terminal is used to receive the signal of a phase obtained from the windings of the electrical machine.

According to one embodiment, the signal obtained from this phase terminal is used to activate the regulator. Thus, when the machine is rotated by the thermal engine, the remanent magnetic field generates an electromagnetic force on the said phase. This electromagnetic force is compared with a threshold, exceeding of which activates the operation of the regulator. In other words, this corresponds to detection of the fact that the alternator is being driven, and that regulation of the voltage must be put into operation.

The second part 300 also comprises an earthing terminal 310 connected to the earth of the rotary electrical machine, and a communication terminal 311 designed to be connected to a computer of the motor vehicle.

According to one embodiment, the second part 300 comprises at least one guide rail 303, with each of the said studs 203 of the first part cooperating with a guide rail 303 in order to form a slide connection. According to this slide connection, the first part 200 forming the central part slides relative to the second part 300 according to the said first axis (z1-z2). In addition, if applicable, each of the closure walls 211 of the first part 200 is supported on a guide rail 303 of the second part 300 in a direction transverse to the said guide rail, in order to stop up the guide rail.

According to one embodiment, the second part 200 comprises two semi-cylindrical guides 302, in order to permit guiding of the first part 200 relative to the second part 300 by cooperation with the two ridges of the receptacle 201.

The second part 300 can comprise a receipt receptacle 301 in which the first part 200 fits in order to form the body of the voltage regulator assembly with a brush-holder 100. Advantageously, the receipt receptacle 301 comprises two ends forming clips 304 which extend projecting in the direction of the first part 200. Thus, the two ends which form clips 304 cooperate with the two projections 204 of the first part, such that the first part 200 can be inserted between the said two ends which form clips 304.

According to one embodiment, the second part 300 comprises a separation wall 308 which extends according to the second axis (y1-y2), with the said separation wall separating the receipt receptacle 301 into two receipt sub-receptacles with an equivalent volume.

As can be seen in FIG. 4, the second part 300 supports on one of the two ends a second excitation terminal 309, the said second terminal 309 being provided with a guide groove 306, in order to cooperate with the said stud 206 of the first terminal 209, so as to facilitate the relative positioning of the first terminal 209 in relation to the second terminal 309. Thus, the excitation signal, the pulse length of which is for example modulated, is sent via the second terminal 309, then the first terminal 209, to the brushes 215, in order to supply the coil of the rotor with power. For example, the stud 206 and the groove 306 extend in directions parallel to the first axis (z1-z2).

According to one embodiment, the receipt receptacle 301 comprises two second walls 305 which delimit it. The two walls extend along a plane perpendicular to the second axis (y1-y2). In particular they extend according to the first axis (z1-z2) in the direction of the first part. Each of the second walls co-operates with each of the first walls, as can be seen in FIG. 5. For this purpose, each of the first walls 205 has an axial length which is sufficient to cover one of the said second walls 305 at least partly.

According to an embodiment shown in FIG. 6 in comparison with FIG. 5, the excess thickness 207 is in the form of a damming part 213 which cooperates with the wall 305 in order to form a dam, and thus limit the penetration of water.

It will be noted that, in the different embodiments of the invention and according to the applications, the addition of a sealing material such as resin or gel may be advantageous, as a complement to the means described, in order to prevent the penetration of water.

In addition, as shown in FIGS. 5 and 6, the second part 300 is superimposed by a seal 307 which extends according to the said second axis, with one of the ends of the seal being supported on one of the second walls 305. Thus, when the voltage regulator assembly with a brush-holder 100 is installed in the electrical machine, the seal 307 extends horizontally.

As can be seen in FIGS. 5, 6 and 7, the second part 300 comprises a heat dissipation plate 319. The second part 300 with the form of a rectangular parallelepiped comprises two faces perpendicular to the first axis (z1-z2). A first face faces towards the first part 100 and the other face 320, known as the outer face, is situated on the other side. For example, the outer face 320 is formed at least partly by the said dissipation plate 319. It is thus possible to optimise the cooling of the voltage regulator assembly with a brush-holder. According to one embodiment, the microcontroller 312 is accommodated in the second part 300, such that it comes into thermal contact with the heat dissipation plate 319. For example, the microcontroller 312 has a form with the largest surface area, and the microcontroller 312 comes into thermal contact with the plate 319 according to this largest surface area. According to one embodiment, the dissipation plate 319 is secured by means of a screw 321 in a hole 322 in the second part, passing through a hole 323 provided in the case of the microcontroller 312.

In addition, the second part 300 can also comprise smoothing capacitors 315 and 316. The capacitor 316 is a smoothing capacitor of the terminal B+ of the battery. For example, the capacitor extends according to the first axis (z1-z2) in order to reduce the size of the voltage regulator assembly with a brush-holder according to the second axis (y1-y2).

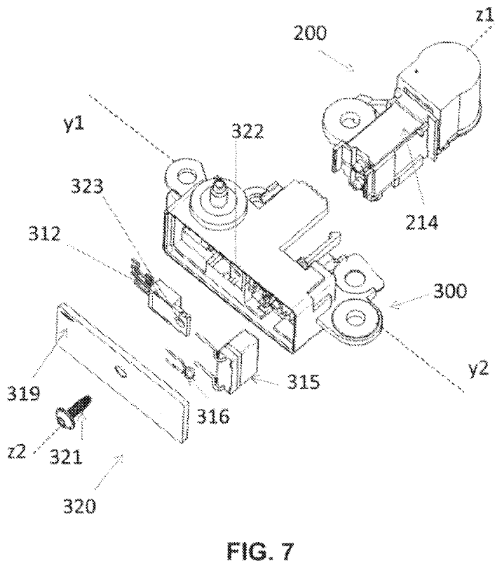

FIG. 8 represents a cross-section of a rotary electrical machine. It comprises a housing 50 provided with cooling windows 199, and a rotor 2 shown in FIG. 1 is accommodated in the said housing. The rotor can rotate around an axis of rotation (X-X) or (x1-x2), and blow air discharged by the said cooling windows 199. The rotor is provided with collector rings 13 shown in FIG. 1. The machine comprises a protective cover 31 which is fitted on the housing 50.

The machine illustrated in FIG. 8 is distinguished from a conventional machine illustrated in FIG. 1 in particular by the following characteristics.

Firstly, it comprises the voltage regulator assembly with a brush-holder 100 which is fitted on the housing 50 inside the protective cover 31. The outer face 320 of the second part 300 of the voltage regulator assembly with a brush-holder 100 can be seen, as well as the dissipation plate 319 in contact with the microcontroller 312. The brushes 215 of the said assembly 100 are in electrical contact with the aforementioned said collector rings 13, in order to emit an excitation current there.

Secondly it comprises a closure ring 198 arranged between the housing 50 and the protective cover 31, in order to prevent input of the air discharged by the cooling windows 199.

Thirdly, it comprises an opening 197, which is delimited on the axis x1-x2 side by a contour 195, and on the other side by a contour 196. This opening 197 permits the intake of cooling air which passes through the protective cover in order to reach the inside of the housing 50.

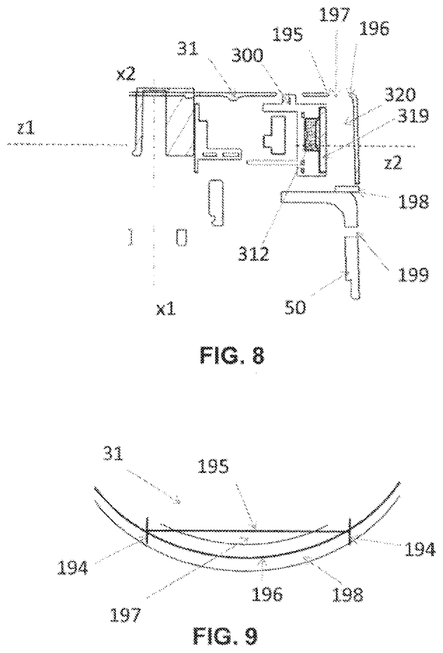

FIG. 9 is a view from above according to the axis X-X of the rotary electrical machine illustrated in FIG. 8. The opening 197 of the protective cover 31 can be seen. In addition, the opening 197 is delimited by two vertical walls 194 of the protective cover 31, such that the cooling air is guided towards the face 320 of the voltage regulator assembly with a brush-holder 100, this face 320 facing towards the exterior of the machine, and extending on the plane perpendicular to the first axis (z1-z2).

1. A voltage regulator assembly with a brush-holder for a rotary electrical machine for a motor vehicle, the assembly comprising:
a brush-holder provided with brushes which come into electrical contact with a rotor of the rotary electrical machine, to provide the rotary electrical machine with an excitation signal;
a microcontroller for regulation of the excitation signal;
a body made of electrically insulating material, the body being globally in the form of a “T”, and in which the brush-holder and the microcontroller are accommodated;
a first part forming a central part of the body in the form of a “T”, and extending according to a first axis, the first part comprising a receptacle forming a brush-holder; and
a second part forming a lateral part of the body in the form of a “T”, and extending according to a second axis which is perpendicular to the first axis, the second part comprising a receptacle forming a case for the regulation microcontroller.

2. The assembly according to claim 1, further comprising at least one slide so that the first part which forms a central part slides relative to the second part according to the first axis.

3. The assembly according to claim 2, wherein the slide connection comprises at least one rail for guiding the second part and studs of the first part, each of the studs cooperating with a guide rail.

4. The assembly according to claim 2, wherein the first part comprises closure walls, each of the closure walls being supported on a guide rail of the second part in a direction transverse to the rail, in order to stop up the guide rail.

5. The assembly according to claim 1, wherein the receptacle for receipt of the brushes comprises at least two ridges, and wherein the second part comprises semi-cylindrical guides, with the two ridges cooperating with the two semi-cylindrical guides to permit guiding of the first part relative to the second.

6. The assembly according to claim 1, wherein the second part comprises a receipt receptacle in which the first part is fitted in order to form the body.

7. The assembly according to claim 6, wherein the receipt receptacle comprises two ends which extend projecting in the direction of the first part, and the two ends cooperate with two projections of the first part, such that the first part is inserted between the two ends.

8. The assembly according to claim 6, wherein the first part comprises two faces perpendicular to the second axis and two first walls which extend projecting according to the first axis in the direction of the second part from the two faces, wherein the receipt receptacle comprises two second walls which delimit it, the two second walls extending according to the first axis in the direction of the first part, and wherein each of the first walls co-operates with one of the second walls.

9. The assembly according to claim 8, wherein each of the first walls has an axial length which is sufficient to cover one of the second walls at least partly.

10. The assembly according to claim 8, wherein at least one of the two faces has an additional thickness.

11. The assembly according to claim 10, wherein the additional thickness comprises a damming part in the form of an “L” covering the first wall, the damming part being formed by a first longitudinal part extending according to the first axis and a second part extending according to the second axis in the direction of the second wall with which the first wall co-operates.

12. The assembly according to claim 6, wherein the second part comprises a separation wall which extends according to the second axis, with the separation wall separating the receipt receptacle into two receipt sub-receptacles with an equivalent volume.

13. The assembly according to claim 1, wherein the second part is superimposed by a seal extending according to the second axis, with one of the ends of the seal being supported on one of the second walls.

14. The assembly according to claim 1, wherein the first part comprises a first excitation terminal comprising a stud which extends according to the first axis, and wherein the second part supports on one of the two ends a second excitation terminal, the second terminal being provided with a guide groove for cooperation with said stud to facilitate the relative positioning of the first terminal in relation to the second terminal.

15. The assembly according to claim 1, wherein the assembly comprises a heat dissipation plate, wherein the second part comprises an inner face facing towards the first part and an outer face facing towards the other side, with the outer face extending on a plane perpendicular to the first axis, and wherein the outer face is formed at least partly by the dissipation plate.

16. The assembly according to claim 1, wherein the microcontroller is accommodated in the second part, such that the microcontroller comes into thermal contact with the heat dissipation plate.

17. A rotary electrical machine comprising:
a housing provided with cooling windows;
a rotor which is accommodated in the housing being able to rotate around an axis of rotation and to blow air discharged by the cooling windows,
the rotor being provided with collector rings to receive an excitation current; and
a voltage regulator assembly with a brush-holder according to claim 1, the brushes of the assembly being in electrical contact with the collector rings.

18. The machine according to claim 17, wherein the voltage regulator assembly with a brush-holder is fitted on the housing accommodated within a protective cover fitted on the housing, and the machine comprises a closure ring arranged between the housing and the protective cover, in order to prevent the input of the air discharged by the cooling windows.

19. The rotary electrical machine according to claim 17, wherein the protective cover is provided with an opening for the intake of cooling air, with the opening being delimited by two vertical walls of the protective cover, such that the cooling air is guided towards a face of the voltage regulator assembly with a brush-holder, which face faces towards the exterior of the machine and extends on the plane perpendicular to the first axis.
